(19) United States
(12) Patent Application Publication
(10) Pub. No.: US 2026/0017238 A1
(43) Pub. Date: Jan. 15, 2026

(54) FILE SYSTEM FULL AND INCREMENTAL REPLICATION TO OBJECT STORAGE SYSTEMS

(71) Applicant: Dell Products L.P., Round Rock, TX (US)

(72) Inventor: Evgeny Popovich, Coquitlam (CA)

(21) Appl. No.: 18/767,305

(22) Filed: Jul. 9, 2024

(51) Int. Cl. G06F 16/182; G06F 16/18

(52) U.S. Cl. CPC G06F 16/1844; G06F 16/1873

(57) ABSTRACT

File system full and incremental replication to object storage systems (e.g., using a computerized tool), is enabled. For example, a system can comprise at least one processor, and at least one memory that stores executable instructions that, when executed by the at least one processor, facilitate performance of operations. The operations can comprise identifying a file system, wherein the file system comprises a group of files, based on an attribute applicable to the file system, determining a dataset identifier representative of the file system, for respective files represented in the group of files, allocating the dataset identifier and allocating respective file identifiers, and copying the group of files to an object store with respective object names corresponding to the respective files, wherein the copying comprises, for the respective files, assigning the dataset identifier to respective object names and assigning the respective file identifiers to the respective object names.

### BACKGROUND

File storage systems organize data hierarchically using directories and subdirectories, which can be accessed via file paths with protocols such as network file system (NFS) or server message block (SMB). File storage systems are often utilized in implementations that require strong consistency and frequent updates, such as home directories and shared file repositories. Conversely, object storage systems store data as discrete objects in a flat address space with unique identifiers. Object storage systems excel in handling large volumes of unstructured data, such as backups and multimedia files, offering scalability and durability. Examples of object storage systems include Amazon Web Services (AWS) Simple Storage Service (S3) and Microsoft Azure Blob Storage. There exists increasing demand for functionality to store file system datasets (e.g., a set of directories and files) in the cloud on object stores using cloud-native object storage application programming interfaces (APIs) (e.g., AWS S3 or Microsoft Azure Blob Storage). Existing file to object replication techniques lack incremental updates and instead utilize a one-to-one relationship between a file and an object, and lose fidelity (e.g., sparseness and hard links). Moreover, directory renames are prohibitively expensive for existing file to object incremental replication techniques.

The above-described background relating to file storage systems and object storage systems is merely intended to provide a contextual overview of some current issues and is not intended to be exhaustive. Other contextual information may become further apparent upon review of the following detailed description.

### BRIEF DESCRIPTION OF DRAWINGS

FIG. 1 is a block diagram of a non-limiting example system in accordance with one or more example embodiments described herein.

FIG. 2 is a block diagram of a non-limiting example computer executable modules in accordance with one or more example embodiments described herein.

FIG. 3 is a diagram of an example bucket structure in accordance with one or more example embodiments described herein.

FIG. 4 is a diagram of an example head version of a file in accordance with one or more example embodiments described herein.

FIG. 5 is a diagram of example file incremental updates in accordance with one or more example embodiments described herein.

FIG. 6 is a diagram of example file incremental updates in accordance with one or more example embodiments described herein.

FIG. 7A is a diagram of example file incremental updates in accordance with one or more example embodiments described herein.

FIG. 7B is a diagram of example file incremental updates in accordance with one or more example embodiments described herein.

FIG. 7C is a diagram of example file incremental updates in accordance with one or more example embodiments described herein.

FIG. 8 is a diagram of example older datasets access in accordance with one or more example embodiments described herein.

FIG. 9 is a diagram of example dataset expiration in accordance with one or more example embodiments described herein.

FIG. 10 is a flow diagram for a process associated with file system full and incremental replication to object storage systems in accordance with one or more example embodiments described herein.

FIG. 11 is a flow diagram for a process associated with file system full and incremental replication to object storage systems in accordance with one or more example embodiments described herein.

FIG. 12 is a flow diagram for a process associated with file system full and incremental replication to object storage systems in accordance with one or more example embodiments described herein.

FIG. 13 is an example, non-limiting computing environment in which one or more embodiments described herein can be implemented.

FIG. 14 is an example, non-limiting networking environment in which one or more embodiments described herein can be implemented.

### DETAILED DESCRIPTION

The subject disclosure is now described with reference to the drawings, wherein like reference numerals are used to refer to like elements throughout. In the following description, for purposes of explanation, numerous specific details are set forth in order to provide a thorough understanding of the subject disclosure. It may be evident, however, that the subject disclosure may be practiced without these specific details. In other instances, well-known structures and devices are shown in block diagram form in order to facilitate describing the subject disclosure.

As alluded to above, file system full and incremental replication to object storage systems can be improved in various ways, and various embodiments are described herein to this end and/or other ends.

According to an example embodiment, a system can comprise at least one processor, and at least one memory that stores executable instructions that, when executed by the processor, facilitate performance of operations, comprising identifying a file system, wherein the file system comprises a group of files, based on an attribute applicable to the file system, determining a dataset identifier representative of the file system, for respective files represented in the group of files, allocating the dataset identifier and allocating respective file identifiers, and copying the group of files to an object store with respective object names corresponding to the respective files, wherein the copying comprises, for the respective files, assigning the dataset identifier to respective object names and assigning the respective file identifiers to the respective object names.

In one or more example embodiments, the above operations further comprise, in response to a determination that a file of the group of files exceeds a defined object store size threshold, dividing the file into corresponding chunks that do not exceed the defined object store size threshold, and the copying of the group of files to the object store can comprise copying the corresponding chunks to the object store.

In one or more example embodiments, the copying of the group of files to the object store can comprise copying a baseline replication of the file system to the object store.

In one or more example embodiments, the copying of the group of files to the object store can comprise copying an incremental replication of the file system to the object store. In this regard, the copying of the incremental replication of the file system to the object store can comprise copying a copy-on-write incremental replication of the file system to the object store. Further in this regard, the group of files can comprise a current group of files, and the copying of the copy-on-write incremental replication can comprise determining changed files in the current group of files relative to a prior version of the group of files in the object store, and determining unchanged files in the current group of files relative to the prior version of the group of files in the object store, copying the changed files from the file system to a current version of the group of files in the object store, wherein the attribute applicable to the file system corresponds to a respective version of the group of files, and generating a pointer from the unchanged files from the prior version of the group of files in the object store to the current version of the group of files in the object store. Further in this regard, the generating the pointer from the unchanged files can comprise assigning, for respective unchanged files of the unchanged files, respective pointers in the prior version of the group of files, wherein the respective pointers point to respective parts of the current version of the group of files. Additionally, or alternatively, the operations further comprise, in response to a determination that a version of the group of files is to be deleted from the object store, determining a pointer, between the version of the group of files and another version of the group of files in the object store, the other version being other than the version and the other version referencing the version of the group of files to be deleted, moving a file corresponding to the pointer to the other version of the group of files, and deleting the version of the group of files from the object store.

In various example embodiments, the copying of the group of files to the object store can comprise copying the group of files to a corresponding bucket in the object store.

In various example embodiments, the object store can comprise a cloud-based object store.

In another example embodiment, a non-transitory machine-readable medium can comprise executable instructions that, when executed by a processor, facilitate performance of operations, comprising determining a file system, wherein the file system comprises data files, based on an attribute applicable to the file system, determining a globally unique dataset identifier representative of the file system, for respective data files of the data files, allocating the globally unique dataset identifier and allocating respective globally unique file identifiers, and copying the data files to an object store with respective object names corresponding to the respective data files of the data files, wherein the copying comprises, for the respective data files of the data files, assigning the globally unique dataset identifier to the respective object names and assigning the respective globally unique file identifiers to the respective object names.

In various example embodiments, the copying of the files to the object store can comprise copying a baseline replication of the file system to the object store.

In various example embodiments, the copying of the files to the object store can comprise copying an incremental replication of the file system to the object store. In this regard, the copying of the incremental replication of the file system to the object store can comprise copying a copy-on-write incremental replication of the file system to the object store. Further in this regard, the data files can comprise current data files, and the copying of the copy-on-write incremental replication can comprise determining changed files in the current data files relative to a prior version of the data files in the object store and determining unchanged files in the current data files relative to the prior version of the data files in the object store, copying the changed files from the file system to a current version of the data files in the object store, wherein the attribute comprises a respective version of the data files, and generating a pointer from the unchanged files from the prior version of the data files in the object store to the current version of the data files in the object store. Further in this regard, the generating the pointer from the unchanged files can comprise assigning, for the unchanged files, respective pointers in the prior version of the data files, and the respective pointers can point to the current version of the data files.

In yet another example embodiment, a method can comprise identifying, by a device comprising at least one processor, a file system, wherein the file system comprises a group of files, based on an attribute applicable to the file system, determining, by the device, a dataset identifier representative of the file system, for each file represented in the group of files, assigning, by the device, the dataset identifier to the file and assigning, by the device, a respective file identifier to the file, and copying, by the device for each file of the group of files, the file to an object store with a respective object name corresponding to the file, wherein the copying comprises applying the dataset identifier to the respective object name for the file and applying a respective file identifier to the respective object name for the file.

In various example embodiments, the copying, for each file, of the file to the object store can comprise performing an incremental replication of the file system to the object store. In this regard, the method can further comprise, in response to a determination that a first version of the group of files is to be deleted from the object store, determining, by the device, a pointer, between the first version of the group of files and a second version of the group of files in the object store, that references the first version of the group of files to be deleted, moving, by the device, a file of the first version of the group of files corresponding to the pointer to the second version of the group of files, and deleting, by the device, the first version of the group of files from the object store. Additionally, or alternatively, the copying, for each file, of the file to the object store can comprise copying, for each file, the file to a corresponding bucket in the object store.

The subject disclosure describes the object layout, format, and operations for storing both full and incremental file system datasets on object stores using not only S3 APIs, but any compatible or equivalent API to achieve the described functionality. In this regard, embodiments herein are cloud-provider-independent.

Embodiments herein enable a full-fidelity file system full and incremental backup and restore from/to an object store, including hard links, soft links, special files, file attributes, alternate data streams, file names encodings, and other suitable elements. Embodiments herein enable creation of self-contained datasets (e.g., without dependency on the source system). Embodiments herein enable efficient cloud storage of incremental changes between datasets in the backup lineage. Embodiments herein comprise a scalable solution, which avoids non-scalable techniques such as scanning a file system to perform incremental copies or keeping a whole file system namespace or block structure in memory.

By utilizing various embodiments described herein, access to the latest dataset in the backup lineage is efficient. In this regard, any dataset in the lineage can be deleted, and various embodiments herein enable cloud storage to serve as a dataset distribution hub, e.g., cloud storage can be used as a source system in fan-out topologies, or as an intermediate system in chaining topologies (supporting both full and incremental dataset transfers). It is noted that various embodiments described herein are cloud-provider-independent and support any file size.

Various embodiments herein can rely on an object stores' ability to filter objects in a bucket based on prefixes. Building object names in a hierarchical manner enables listing all objects owned by the specified dataset, listing all objects in a dataset owned by the specified file, obtaining a complete file layout (e.g., non-sparse and sparse file regions), and obtaining a partial file layout for the given offset/length pair.

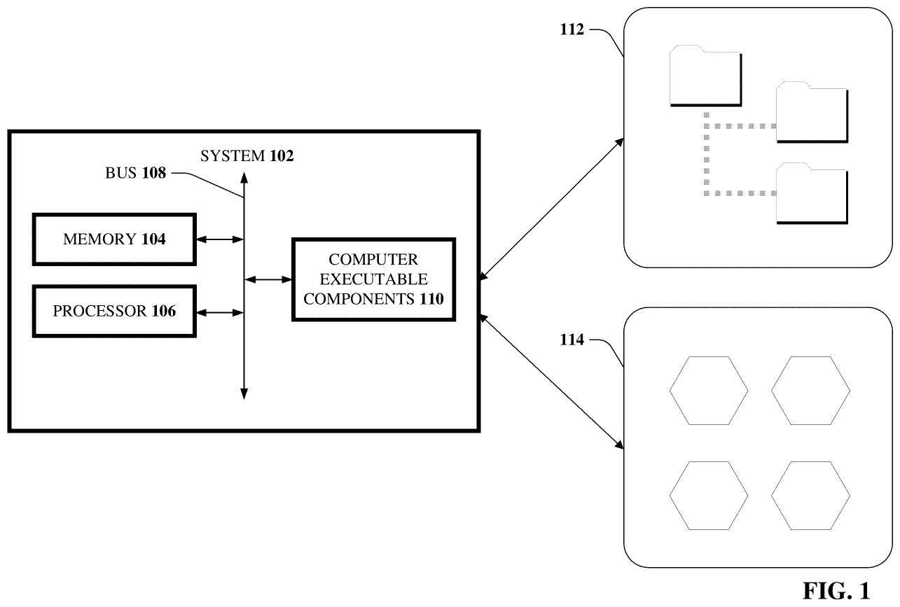

Turning now to FIG. 1, there is illustrated an example, non-limiting system 102 in accordance with one or more example embodiments herein. System 102 can comprise a computerized tool, which can be configured to perform various operations relating to file system full and incremental replication to object storage systems. The system 102 can comprise one or more of a variety of components, such as memory 104, processor 106, bus 108, and/or computer executable components 110. In various embodiments, one or more of the memory 104, processor 106, bus 108, and/or computer executable components 110 can be communicatively or operably coupled (e.g., over a bus or wireless network) to one another to perform one or more functions of the system 102.

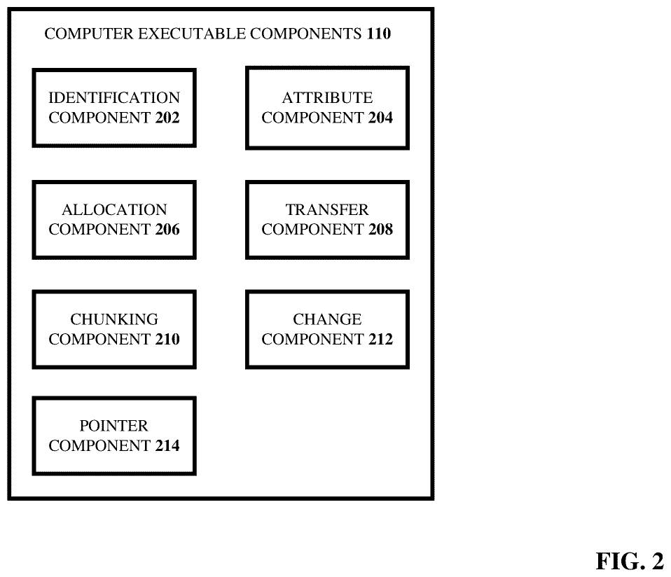

FIG. 2 illustrates a block diagram of example, non-limiting computer executable components 110 that can facilitate file system full and incremental replication to object storage systems in accordance with one or more embodiments described herein. Repetitive description of like elements employed in other embodiments described herein is omitted for sake of brevity. As shown in FIG. 2, the one or more computer executable components 110 can comprise the identification component 202, attribute component 204, allocation component 206, transfer component 208, chunking component 210, change component 212, and/or pointer component 214. It is noted that while various components described herein can perform one or more corresponding functions, processes, or actions, the computer executable components 110 as a whole and/or the processor 106 can be configured to perform one or more of the described functions, processor, or actions.

According to an embodiment, the identification component 202 can identify a file system 112. It is noted that, in various embodiments, the file system 112 can comprise a group of files. The identification component 202 can identify the file system 112 in response to a prior registration or a new registration with the system 102. In various embodiments, the identification component 202 can identity the file system 112 using corresponding file system metadata, partition tables, operating system tools, file system drivers, volume labels, or other suitable identifiers applicable to the file system 112. In various embodiments, the file system 112 can comprise a computer, server, mobile device (e.g., smartphone, tablet, wearable device), hard drives, solid state drives, or other suitable devices.

According to an embodiment, the attribute component 204 can, based on an attribute applicable to the file system 112, determine a dataset identifier representative of the file system 112. In various embodiments, the dataset identifier can comprise globally unique dataset identifier (ID). According to an embodiment, the allocation component 206 can, for respective files represented in the group of files, allocate the dataset identifier and allocate respective file identifiers. In this regard, each dataset, before replication from a file system 112 to an object store 114, is allocated a globally unique dataset ID (gdsid) (e.g., a dataset identifier). These gdsids can be later utilized to identify concrete versions of a file. Embodiments herein can rely on generation and allocation globally unique file IDs (gfids) (e.g., respective file identifiers) for files and directories, and utilization of those gfids to identify objects that are to be updated in the cloud on incremental updates. It is noted that a single gfid is utilized for all versions of a file. For example, if a file has three versions (e.g., snapshots), all of them will share the same gfid. To identify a specific version in the cloud, a {gfid, gdsid} tuple is utilized herein.

According to an embodiment, the transfer component 208 can copy the group of files to an object store 114 with respective object names corresponding to the respective files. In this regard, the copying by the transfer component 208 can comprise, for the respective files, assigning the dataset identifier to respective object names and assigning the respective file identifiers to the respective object names. In various embodiments, the transfer component 208 can determine an object storage service applicable to the file system 112, authenticate and/or configure with the object store 114 using applicable credentials, such as access keys, service accounts, or other suitable credentials. The transfer component 208 can further prepare the files on the file system 112, which can comprise compressing the files or other suitable file preparation.

In various embodiments, the copying (e.g., via the transfer component 208) of the group of files to the object store 114 can comprise copying the group of files to a corresponding bucket in the object store 114. In this regard, the files from the file system 112 can be copied to a bucket in the object store 114 to which the corresponding files are registered. In various embodiments, the object store 114 can comprise a cloud-based object store 114. In various embodiments, the copying (e.g., via the transfer component 208) of the group of files to the object store 114 can comprise copying a baseline replication of the file system 112 to the object store 114. In this regard, the baseline replication of the file system 112 to the object store 114 can comprise a full replication, in that the entire dataset from the file system 112 is copied to the object store 114. The baseline replication of the file system 112 can occur as an initial replication to the object store 114 or before an incremental replication to the object store 114. In an incremental replication, only the data that has changed since the last replication is copied from the file system 112 to the object store 114.

In various embodiments, the copying (e.g., via the transfer component 208) of the group of files to the object store can comprise copying an incremental replication of the file system 112 to the object store 114. In this regard, the copying of the incremental replication of the file system 112 to the object store 114 can comprise copying a copy-on-write (CoW) incremental replication of the file system 112 to the object store 114. By utilizing CoW, changes to the object store 114 (e.g., changes to a corresponding object or a chunk) are deferred until necessary, for instance, by leveraging existing data in other corresponding datasets in the object store 114 rather than re-copying from the file system 112. In one or more embodiments, the group of files can comprise a current group of files, the copying (e.g., via the transfer component 208) of the CoW incremental replication can comprise determining (e.g., via the change component 212) changed files in the current group of files relative to a prior version of the group of files in the object store 114 (e.g., in a prior corresponding dataset or snapshot), and determining (e.g., via the change component 212) unchanged files in the current group of files relative to the prior version of the group of files in the object store 114. The transfer component 208 can then copy the changed files from the file system 112 to a current version of the group of files in the object store 114 (e.g., a current dataset or snapshot, such as a HEAD dataset), in which the attribute applicable to the file system 112 corresponds to a respective version of the group of files. The transfer component 208 can then generate a pointer (e.g., implicit DITTO) from the unchanged files from the prior version of the group of files in the object store 114 (e.g., prior dataset or snapshot) to the current version of the group of files in the object store 114 (e.g., current dataset or snapshot, such as the HEAD dataset). It is noted that, in various embodiments, the generating (e.g., via the transfer component 208) of the pointer from the unchanged files can comprise assigning, for respective unchanged files of the unchanged files, respective pointers (e.g., DITTOs) in the prior version of the group of files. In this regard, the respective pointers (e.g., DITTOs) point to respective parts of the current version of the group of files.

According to an embodiment, the chunking component 210 can, in response to a determination that a file of the group of files exceeds a defined object store size threshold, divide the file into corresponding chunks that do not exceed the defined object store size threshold. Thus, a group of chunks in the object store 114 can represent a file copied from the file system 112. In this regard, the copying (e.g., via the transfer component 208) of the group of files to the object store 114 can comprise copying the corresponding chunks to the object store 114. In some embodiments, if metadata herein (e.g., applicable to the file represented by the chunks) is small (e.g., less than or equal to 2 kb), then the metadata can be stored in the user-defined metadata of the first chunk corresponding to a file. If the metadata herein is large (e.g., greater than 2 kb), then a new object can be created to store the attributes.

In various embodiments, the pointer component 214 can, in response to a determination that a version of the group of files is to be deleted from the object store 114, determine a pointer (e.g., a DITTO), between the version of the group of files and another version of the group of files in the object store (e.g., the other version being other than the version and the other version referencing the version of the group of files to be deleted). The transfer component 208 can then move a file corresponding to the pointer to the other version of the group of files and delete the version of the group of files from the object store 114. In this regard, the amount of data that needs to be copied from the file system 112 to the object store 114 is reduced by transferring the applicable data from one dataset in the object store to another dataset in the object store (e.g., one snapshot to another), thus reducing costs and saving time during data replication.

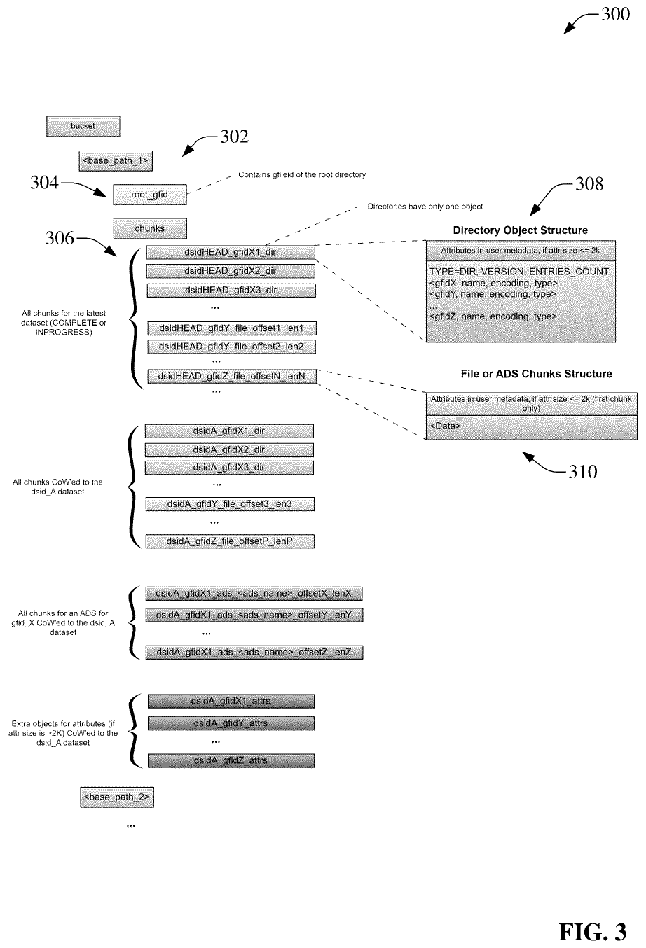

FIG. 3 is a diagram of an example bucket structure 300 in accordance with one or more example embodiments described herein. In various embodiments, the bucket structure 300 can comprise a lineage of datasets (e.g., baseline and/or incremental) using objects stored in an object store 114 (e.g., presented in the cloud). In this example, the datasets are stored with the <base_path_1> prefix 302, so it is possible to store multiple lineages in the same cloud store bucket. The root_gfid object 304 contains the gfid of the dataset root directory. The <base_path_1/chunks/> prefix (e.g., folder) 306 contains objects representing all the versions of all the directories, files, alternate data streams, and/or files or directories attributes. The directory object structure 308 can contain attributes in user metadata (e.g., if attribute size is less than or equal to 2 kb). For instance, the file or alternate data stream (ADS) chunk structure 310 contain attributes in user metadata (e.g., if attribute size is less than or equal to 2 kb) (e.g., of a first chunk only). In various embodiments, such attributes can comprise access bits (e.g., access control lists that define permissions for read and/or writing of files herein). In some embodiments, if metadata herein is small (e.g., less than or equal to 2 kb), then the metadata can be stored in the user-defined metadata of the first chunk corresponding to a file. If the metadata herein is large (e.g., greater than 2 kb), then a new object can be created to store the attributes.

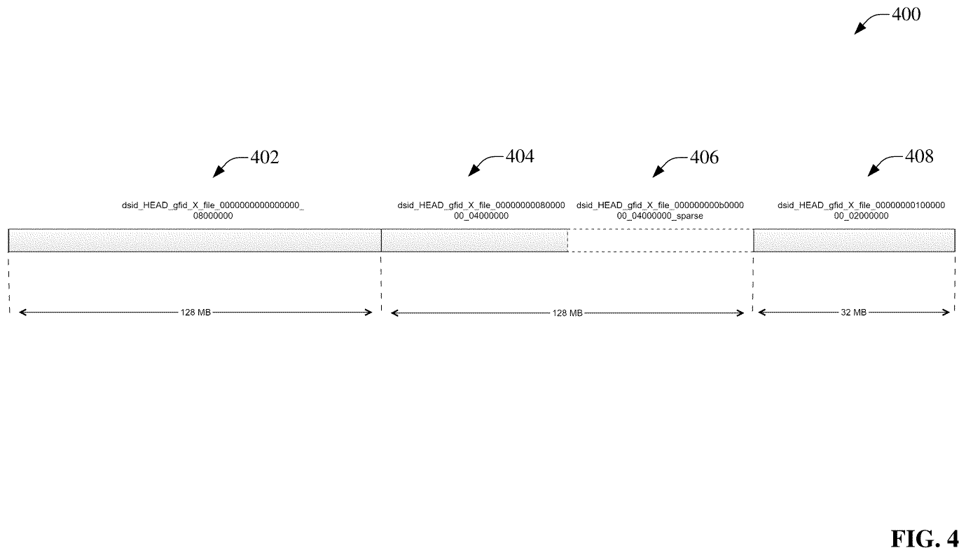

FIG. 4 is a diagram of an example head version 400 of a file in accordance with one or more example embodiments described herein. In various embodiments herein, files can be split into 128 MB object chunks, so one file can be represented by multiple objects, for instance, if a file is larger than 128 MB. In various embodiments, files herein can comprise holes (e.g., sparse regions) in the files. In FIG. 4, as a nonlimiting example, four objects are depicted (e.g., objects 402, 404, 406, and 408). In FIG. 4, objects 402 and 404 can have data stored therein, which thus represent data chunks of the corresponding file. The third object (e.g., object 406) can comprise a_sparse suffix, which can be empty (e.g., a sparse region). The object 408 can also have data stored thereon. The first element in the name of the objects can be the global dataset ID. The second element in the name of the objects can be the global file ID. The third element in the name of the objects can be the offset (e.g., where the chunk starts). The next element in the name of the objects can be the length of a particular chunk. The foregoing is how a file in the HEAD (e.g., latest dataset) can be represented.

Embodiments herein define a HEAD dataset (e.g., objects with dsidHEAD prefix), which represents the latest dataset in a lineage of datasets. In various embodiments described herein, dsidHEAD is fully populated. In this regard, there are no gaps in file regions. If there is no transfer-in-progress, then dsid {latest_gdsid} content is dsidHEAD content. In a nonlimiting example, the layout herein splits files on 128 MB boundaries. There can be a single chunk representing the whole 128 MB range (e.g., as with object 402), or there could be multiple chunks (e.g., as with object 404 and object 406), depending on if there are sparse regions in a 128 MB extent (e.g., object 406). It is noted that chunks herein do not cross the 128 MB boundary (e.g., or another suitable boundary)—not in HEAD and not in snapshots/datasets. The foregoing enables efficient file layout lookup. In various embodiments, the naming convention for objects representing file chunks can be: <gdsid>_<gfid>_file_<hex_offset>_<hex_len> [_sparse]

For example, the HEAD version of a file can appear as depicted in FIG. 4. The example in FIG. 4 represents a 288 MB file, with sparse region 192 MB to 256 MB. Such a file is represented using four objects (e.g., objects 402, 404, 406, and 408), three data objects (e.g., objects 402, 404, and 408) and one empty object (e.g., object 406) to represent the sparse region. With this approach, the layout is stored in objects names, so that filtering objects by <gdsid>_<gfid>_file prefix will yield a file version layout. Using the hex format for offset facilitates eases in listing layout, for instance, starting from a specific region of a file.

The length part of object names above can be a fixed-length 32-bit number in hex, though other suitable lengths are envisaged, and the fixed-length 32-bit number is thus nonlimiting. Chunks up to 2 GB in size inclusive, for instance, can be represented using this layout (e.g., assuming the chunk boundary is a 2\hat{ }x number). However, the length field size does not have to be constant and can thus be any number, since there is no filtering expected based on the length part of the name.

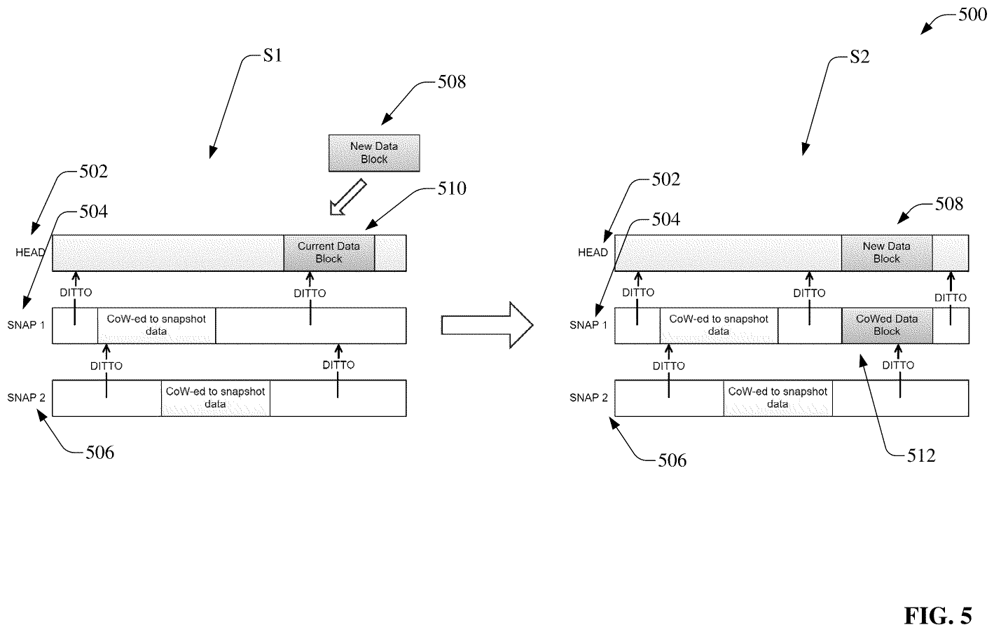

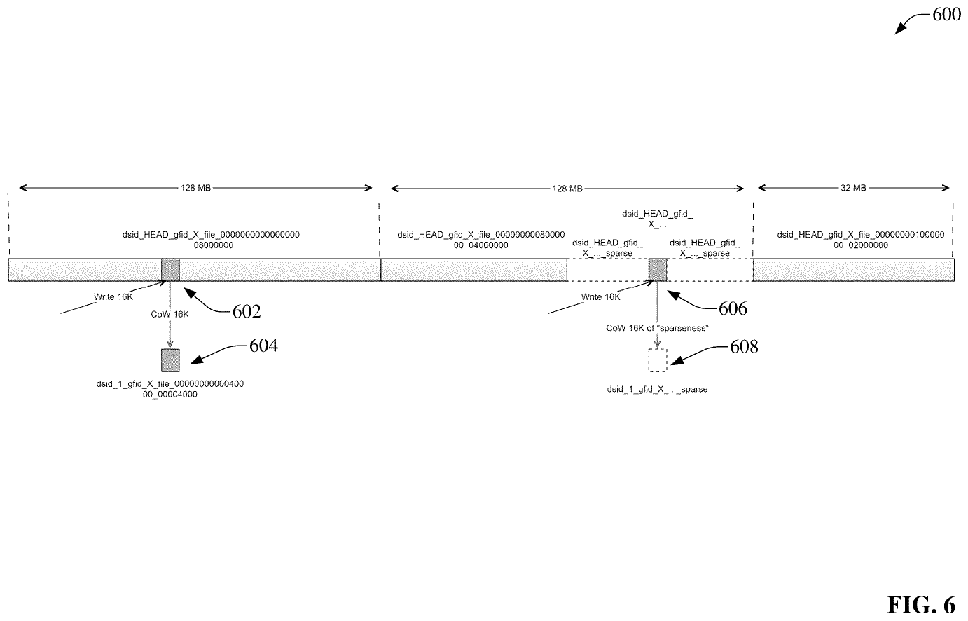

FIG. 5 is a diagram 500 of example file incremental updates in accordance with one or more example embodiments described herein. For incremental updates, a CoW approach is utilized (e.g., via the system 102). With this approach, the latest dataset (e.g., HEAD) is fully populated, and previous snapshots have either data or pointers (e.g., explicit or implicit, depending on the implementation) to the next more recent dataset in line (e.g., “DITTO” regions). In various implementations herein, the DITTO pointers utilized herein are implicit (e.g., no physical representation). This CoW approach is depicted in FIG. 5 herein. For instance, at step S1, a new data block 508 is to be copied to the HEAD 502 in the place of current data block 510 in the HEAD 502. Thus, at step S2, the new data block 508 is copied to the HEAD 502, and the current data block 510 is copy-on-written (CoWed) to snapshot 1 504 and represented in CoWed data block 512. In this regard, a DITTO from snapshot 2 506 can point to the CoWed data block 512. A DITTO herein can be utilized (e.g., via the system 102) when a given snapshot does not contain data, and instead points to a different snapshot (e.g., the HEAD dataset or in the head of a file system herein). FIG. 6 is a diagram of example file incremental updates in accordance with one or more example embodiments described herein. As shown in FIG. 6, writes (e.g., via the transfer component 208) on top of the latest version (e.g., snapshot) will copy existing data to the previous snapshot, and write the new data in place. In FIG. 6, a new HEAD object 600 is depicted. Constructing new HEAD objects 600 (e.g., 128 MB chunk) (e.g., via the transfer component 208) is performed from the new updates, which are uploaded (e.g., via the transfer component 208) to the cloud (e.g., object store 114), and parts of the existing HEAD objects (e.g., in the object store 114), to avoid copying the whole 128 MB chunk to the cloud (e.g., object store 114). The update is performed (e.g., via the transfer component 208, for instance) using server-side copy S3 APIs or other suitable APIS, e.g., UploadPartCopy ( ) in AWS S3. For instance, if 16 kb of a chunk representing a file change are written to 602, the previous data is CoWed to 604 in a previous snapshot. Similarly, if 16 kb of a chunk representing a file change are written to 606 in a sparse region of the HEAD objects 600, the sparseness is CoWed to 608 in the previous snapshot.

It is noted that the namespace representation can be performed (e.g., via the system 102) by using directory objects and storing a whole directory object for each directory version. In various embodiments herein, there are not differences (e.g., diffs) represented in the cloud (e.g., in object store 114) between versions of the same directory. In various embodiments, a directory herein can be represented using the same naming schema, but with the_dir suffix instead of the_file one.

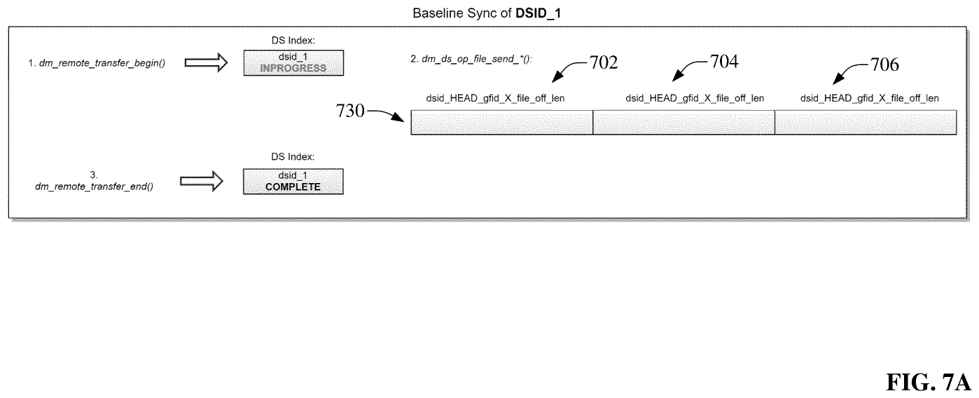

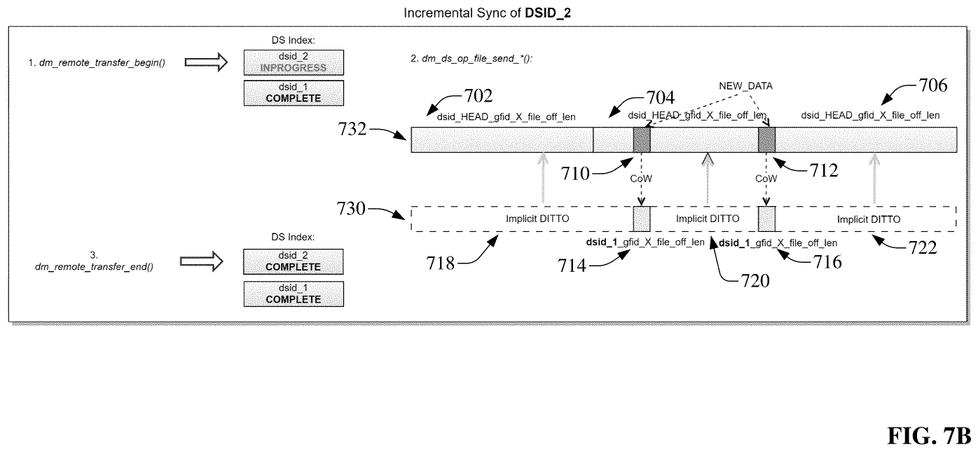

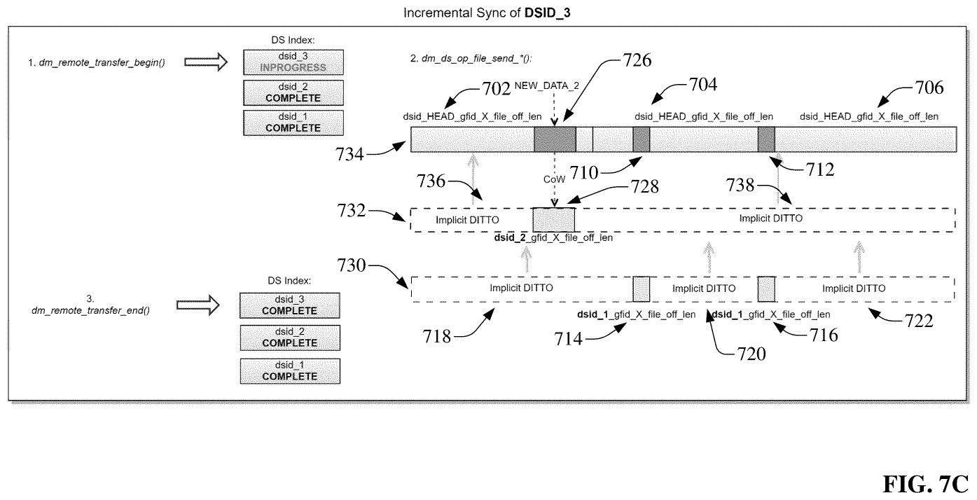

FIGS. 7A, 7B, and 7C are diagrams of example file incremental updates in accordance with one or more example embodiments described herein. FIG. 7A shows a baseline sync of DSID_1 730, which can comprise the HEAD dataset in FIG. 7A comprising objects 702, 704, and 706. FIG. 7B shows an incremental sync of DSID_2 732 (e.g., the next snapshot). Here, new data 710 and 712 is to be written. Thus, DSID_2 732 can become current HEAD dataset in FIG. 7B and can retain the unchanged data from DSID_1 730. Thus, the data previously in the place of data 710 and data 712 can be CoWed to 714 and 716, respectively, in dataset 730, with implicit DITTOs 718, 720, and 722 pointing toward the unchanged data in DSID_2 732. FIG. 7C shows an incremental sync of DSID_3 734 (e.g., the next snapshot). Here, new data 726 is to be written. Thus, DSID_3 734 can become current HEAD dataset in FIG. 7C and can retain the unchanged data from DSID_2 732 and DSID_1 730. Thus, the data previously in the place of data 726 can be CoWed to 728, in DSID_2 732, with implicit DITTOs 736 and 738 pointing toward the unchanged data in DSID_3 734.

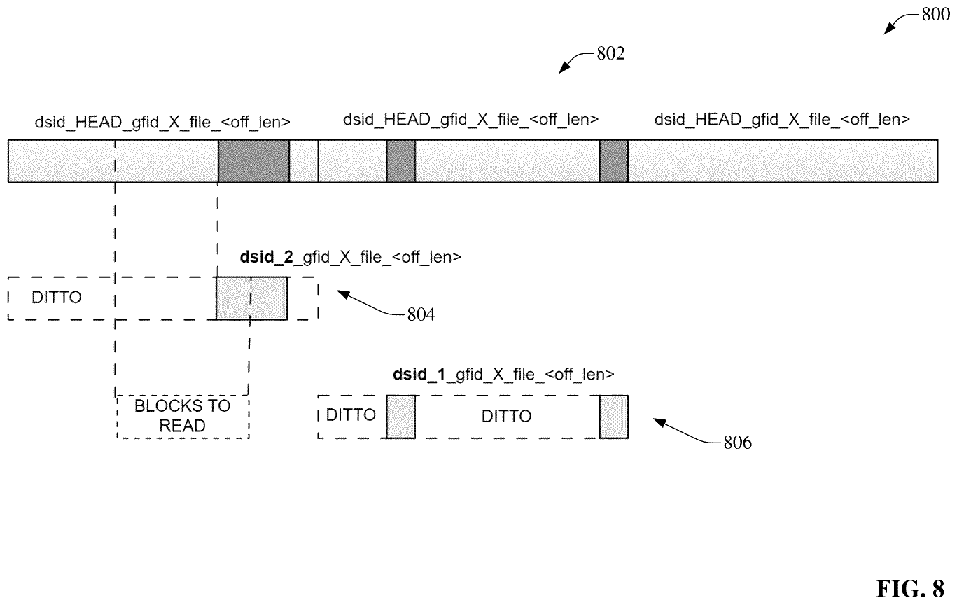

FIG. 8 is a diagram 800 of example older datasets access in accordance with one or more example embodiments described herein. In this nonlimiting example, it is assumed that there is an attempt to read a version of a file from DSID_1 806 dataset, with offset/length within the first chunk (chunk zero). The corresponding order of the operations (e.g., as facilitated via the system 102) can be as follows:
1. LIST OBJECTS (prefix=“dsid_1_gfid_x_file_”)<-no required range coverage.
2. LIST OBJECTS (prefix=“dsid_2_gfid_x_file_”)<-still no required range coverage.
3. LIST OBJECTS (prefix=“dsid_HEAD_gfid_x_file_”).
4. GET (dsid_HEAD_gfid_X_file_off_len, <HEAD object relevant range>)=>got HEAD data (e.g., DSID_3 802).
5. GET (dsid_2_gfid_X_file_off_len, <dsid_2 object relevant range>)=>got DSID_2 804 data.

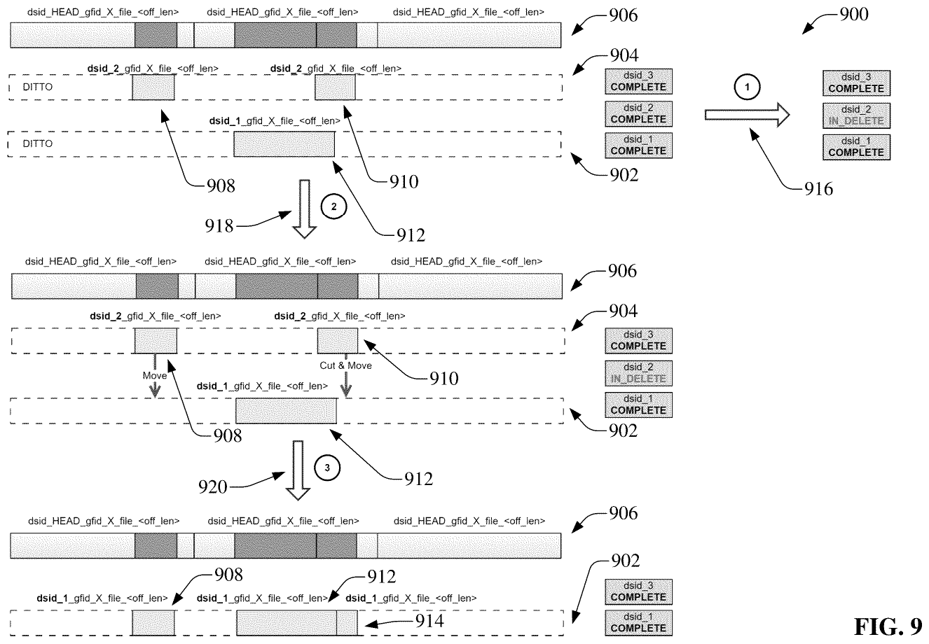

FIG. 9 is a diagram 900 of example dataset expiration in accordance with one or more example embodiments described herein. In various embodiments described herein, dataset expiration can require transferring (e.g., via the system 102 such as via the transfer component 208) all the chunks a dataset owns to the previous dataset, as well as deleting (e.g., or merging blocks of) the chunks that are already owned by the older dataset. As there is no object “rename” operation in the object store (e.g., object store 114), the rename/ownership transfer can be achieved using server-side copy processes followed by deletion of the original chunk. This approach can require an IN_DELETE state for the dataset being removed to ensure (1) there are no attempts to CoW chunks to an IN_DELETE dataset, and (2) there are no attempts to read IN_DELETE datasets. To avoid extra complexity (e.g., locking, transactions, etc.), in various embodiments herein, only one dataset can be in IN_DELETE state for a chain of datasets in the cloud. FIG. 9 illustrates an example of DSID_2 904 dataset expiration. In step 916, DSID_3 906 (e.g., HEAD), DSID_2 904, and DSID_1 902 are depicted, and DSID_2 904 is to be removed/deleted. DSID_2 904 can comprise chunks 908 and 910, and DSID_1 902 can comprise chunk 912 that has some overlap with chunk 910. In step 918, chunk 908 is moved to DSID_1 902, and chunk 910 is cut and moved to DSID_1 902, resulting in chunk 914 in DSID_1 902 in step 920. In this regard, chunk 914 can represent the non-overlapping data between chunk 910 and chunk 912. DSID_2 904 can then be deleted (e.g., via the system 102 herein).

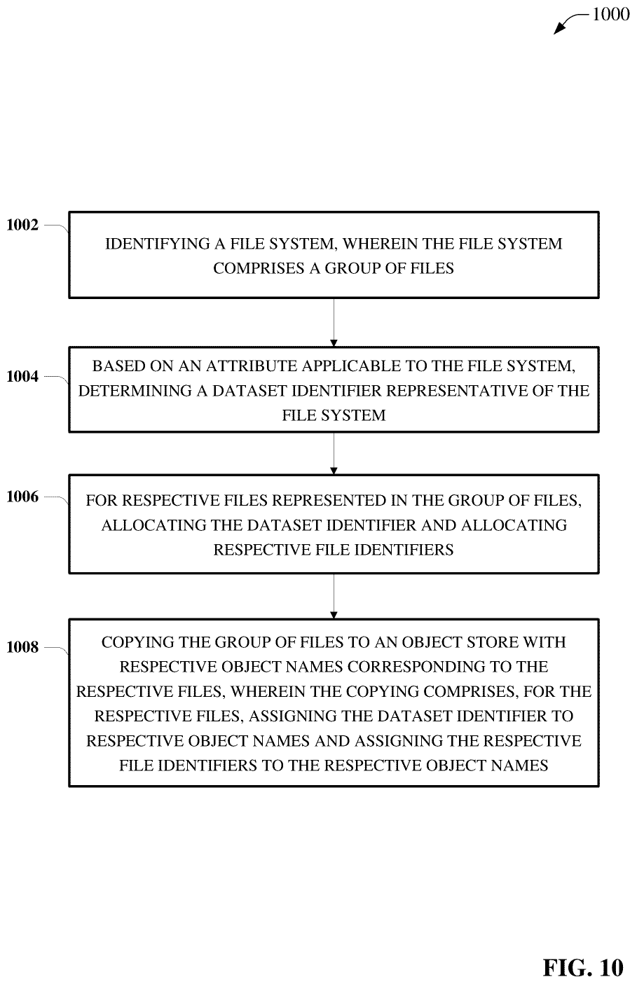

FIG. 10 illustrates a flow diagram for a process 1000 associated with file system full and incremental replication to object storage systems in accordance with one or more embodiments described herein. At 1002, the process 1000 can comprise identifying (e.g., via the identification component 202) a file system (e.g., file system 112), wherein the file system 112 comprises a group of files. At 1004, the process 1000 can comprise, based on an attribute applicable to the file system 112, determining (e.g., via the attribute component 204) a dataset identifier representative of the file system 112. At 1006, the process 1000 can comprise, for respective files represented in the group of files, allocating (e.g., via the allocation component 206) the dataset identifier and allocating (e.g., via the allocation component 206) respective file identifiers. At 1008, the process 1000 can comprise copying (e.g., via the transfer component 208) the group of files to an object store 114 with respective object names corresponding to the respective files, wherein the copying comprises, for the respective files, assigning the dataset identifier to respective object names and assigning the respective file identifiers to the respective object names.

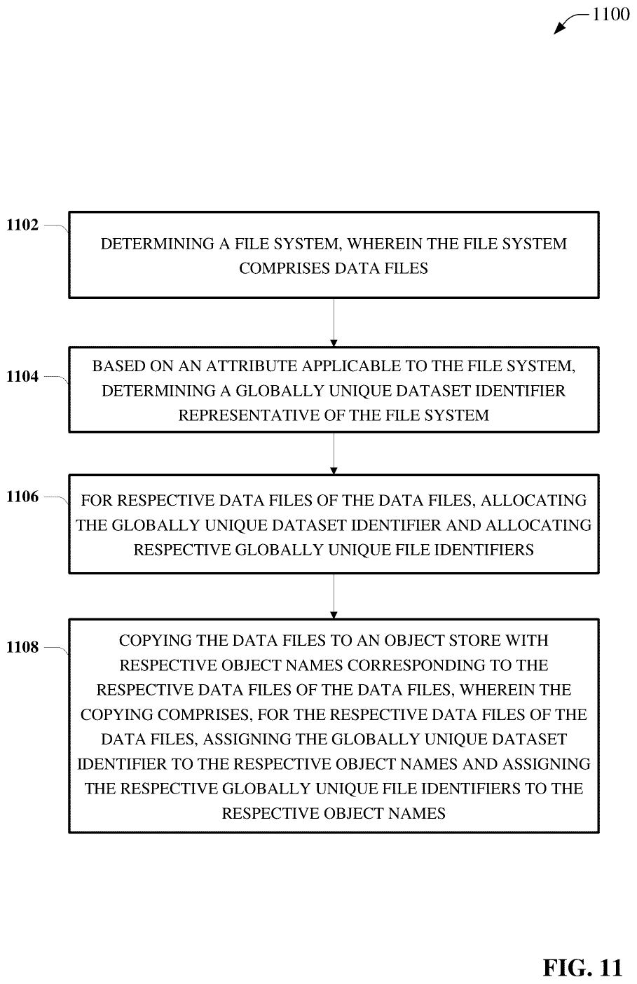

FIG. 11 illustrates a flow diagram for a process 1100 associated with file system full and incremental replication to object storage systems in accordance with one or more embodiments described herein. At 1102, the process 1100 can comprise determining (e.g., via the identification component 202) a file system (e.g., file system 112), wherein the file system 112 comprises data files. At 1104, the process 1100 can comprise, based on an attribute applicable to the file system 112, determining (e.g., via the attribute component 204) a globally unique dataset identifier representative of the file system 112. At 1106, the process 1100 can comprise, for respective data files of the data files, allocating (e.g., via the allocation component 206) the globally unique dataset identifier and allocating (e.g., via the allocation component 206) respective globally unique file identifiers. At 1108, the process 1100 can comprise copying (e.g., via the transfer component 208) the data files to an object store 114 with respective object names corresponding to the respective data files of the data files, wherein the copying comprises, for the respective data files of the data files, assigning the globally unique dataset identifier to the respective object names and assigning the respective globally unique file identifiers to the respective object names.

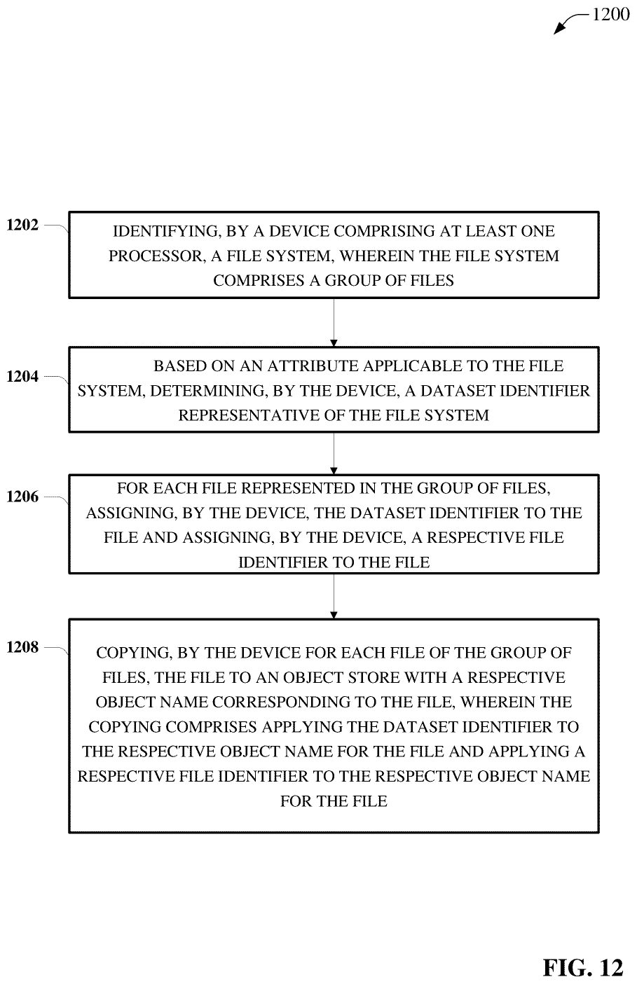

FIG. 12 illustrates a flow diagram for a process 1200 associated with file system full and incremental replication to object storage systems in accordance with one or more embodiments described herein. At 1202, the process 1200 can comprise identifying (e.g., via the identification component 202), by a device comprising at least one processor (e.g., processor 106), a file system (e.g., file system 112), wherein the file system 112 comprises a group of files. At 1204, the process 1200 can comprise, based on an attribute applicable to the file system 112, determining (e.g., via the attribute component 204), by the device, a dataset identifier representative of the file system 112. At 1206, the process 1200 can comprise, for each file represented in the group of files, assigning (e.g., via the allocation component 206), by the device, the dataset identifier to the file and assigning (e.g., via the allocation component 206), by the device, a respective file identifier to the file. At 1208, the process 1200 can comprise copying (e.g., via the transfer component 208), by the device for each file of the group of files, the file to an object store 114 with a respective object name corresponding to the file, wherein the copying comprises applying the dataset identifier to the respective object name for the file and applying a respective file identifier to the respective object name for the file.

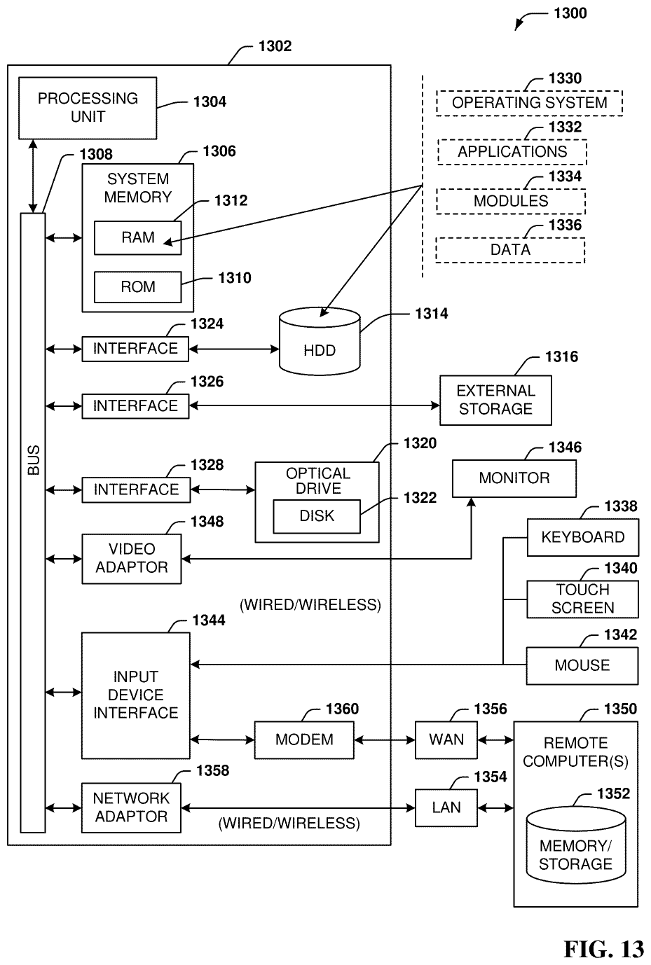

In order to provide additional context for various embodiments described herein, FIG. 13 and the following discussion are intended to provide a brief, general description of a suitable computing environment 1300 in which the various embodiments of the embodiment described herein can be implemented. While the embodiments have been described above in the general context of computer-executable instructions that can run on one or more computers, those skilled in the art will recognize that the embodiments can be also implemented in combination with other program modules and/or as a combination of hardware and software.

Generally, program modules include routines, programs, components, modules, data structures, etc., that perform particular tasks or implement particular abstract data types. Moreover, those skilled in the art will appreciate that the various methods can be practiced with other computer system configurations, including single-processor or multiprocessor computer systems, minicomputers, mainframe computers, Internet of Things (IoT) devices, distributed computing systems, as well as personal computers, hand-held computing devices, microprocessor-based or programmable consumer electronics, and the like, each of which can be operatively coupled to one or more associated devices.

The illustrated embodiments of the embodiments herein can also be practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data, or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory, or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries, or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared, and other wireless media.

With reference again to FIG. 13, the example environment 1300 for implementing various embodiments of the aspects described herein includes a computer 1302, the computer 1302 including a processing unit 1304, a system memory 1306 and a system bus 1308. The system bus 1308 couples system components including, but not limited to, the system memory 1306 to the processing unit 1304. The processing unit 1304 can be any of various commercially available processors. Dual microprocessors and other multi-processor architectures can also be employed as the processing unit 1304.

The system bus 1308 can be any of several types of bus structure that can further interconnect to a memory bus (with or without a memory controller), a peripheral bus, and a local bus using any of a variety of commercially available bus architectures. The system memory 1306 includes ROM 1310 and RAM 1312. A basic input/output system (BIOS) can be stored in a non-volatile memory such as ROM, erasable programmable read only memory (EPROM), EEPROM, which BIOS contains the basic routines that help to transfer information between elements within the computer 1302, such as during startup. The RAM 1312 can also include a high-speed RAM such as static RAM for caching data.

The computer 1302 further includes an internal hard disk drive (HDD) 1314 (e.g., EIDE, SATA), one or more external storage devices 1316 (e.g., a magnetic floppy disk drive (FDD) 1316, a memory stick or flash drive reader, a memory card reader, etc.) and an optical disk drive 1320 (e.g., which can read or write from a disk 1322, such as a CD-ROM disc, a DVD, a BD, etc.). While the internal HDD 1314 is illustrated as located within the computer 1302, the internal HDD 1314 can also be configured for external use in a suitable chassis (not shown). Additionally, while not shown in environment 1300, a solid-state drive (SSD) could be used in addition to, or in place of, an HDD 1314. The HDD 1314, external storage device(s) 1316 and optical disk drive 1320 can be connected to the system bus 1308 by an HDD interface 1324, an external storage interface 1326 and an optical drive interface 1328, respectively. The interface 1324 for external drive implementations can include at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 1302, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 1312, including an operating system 1330, one or more application programs 1332, other program modules 1334 and program data 1336. All or portions of the operating system, applications, modules, and/or data can also be cached in the RAM 1312. The systems and methods described herein can be implemented utilizing various commercially available operating systems or combinations of operating systems.

Computer 1302 can optionally comprise emulation technologies. For example, a hypervisor (not shown) or other intermediary can emulate a hardware environment for operating system 1330, and the emulated hardware can optionally be different from the hardware illustrated in FIG. 13. In such an embodiment, operating system 1330 can comprise one virtual machine (VM) of multiple VMs hosted at computer 1302. Furthermore, operating system 1330 can provide runtime environments, such as the Java runtime environment or the .NET framework, for applications 1332. Runtime environments are consistent execution environments that allow applications 1332 to run on any operating system that includes the runtime environment. Similarly, operating system 1330 can support containers, and applications 1332 can be in the form of containers, which are lightweight, standalone, executable packages of software that include, e.g., code, runtime, system tools, system libraries and settings for an application.

Further, computer 1302 can be enabled with a security module, such as a trusted processing module (TPM). For instance, with a TPM, boot components hash next in time boot components, and wait for a match of results to secured values, before loading a next boot component. This process can take place at any layer in the code execution stack of computer 1302, e.g., applied at the application execution level or at the operating system (OS) kernel level, thereby enabling security at any level of code execution.

A user can enter commands and information into the computer 1302 through one or more wired/wireless input devices, e.g., a keyboard 1338, a touch screen 1340, and a pointing device, such as a mouse 1342. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 1304 through an input device interface 1344 that can be coupled to the system bus 1308, but can be connected by other interfaces, such as a parallel port, an IEEE 1394 serial port, a game port, a USB port, an IR interface, a BLUETOOTH® interface, etc.

A monitor 1346 or other type of display device can also be connected to the system bus 1308 via an interface, such as a video adapter 1348. In addition to the monitor 1346, a computer typically includes other peripheral output devices (not shown), such as speakers, printers, etc.

The computer 1302 can operate in a networked environment using logical connections via wired and/or wireless communications to one or more remote computers, such as a remote computer(s) 1350. The remote computer(s) 1350 can be a workstation, a server computer, a router, a personal computer, portable computer, microprocessor-based entertainment appliance, a peer device or other common network node, and typically includes many or all of the elements described relative to the computer 1302, although, for purposes of brevity, only a memory/storage device 1352 is illustrated. The logical connections depicted include wired/wireless connectivity to a local area network (LAN) 1354 and/or larger networks, e.g., a wide area network (WAN) 1356. Such LAN and WAN networking environments are commonplace in offices and companies, and facilitate enterprise-wide computer networks, such as intranets, all of which can connect to a global communications network, e.g., the Internet.

When used in a LAN networking environment, the computer 1302 can be connected to the local network 1354 through a wired and/or wireless communication network interface or adapter 1358. The adapter 1358 can facilitate wired or wireless communication to the LAN 1354, which can also include a wireless access point (AP) disposed thereon for communicating with the adapter 1358 in a wireless mode.

When used in a WAN networking environment, the computer 1302 can include a modem 1360 or can be connected to a communications server on the WAN 1356 via other means for establishing communications over the WAN 1356, such as by way of the Internet. The modem 1360, which can be internal or external and a wired or wireless device, can be connected to the system bus 1308 via the input device interface 1344. In a networked environment, program modules depicted relative to the computer 1302 or portions thereof, can be stored in the remote memory/storage device 1352. It will be appreciated that the network connections shown are examples and other means of establishing a communications link between the computers can be used.

When used in either a LAN or WAN networking environment, the computer 1302 can access cloud storage systems or other network-based storage systems in addition to, or in place of, external storage devices 1316 as described above. Generally, a connection between the computer 1302 and a cloud storage system can be established over a LAN 1354 or WAN 1356 e.g., by the adapter 1358 or modem 1360, respectively. Upon connecting the computer 1302 to an associated cloud storage system, the external storage interface 1326 can, with the aid of the adapter 1358 and/or modem 1360, manage storage provided by the cloud storage system as it would other types of external storage. For instance, the external storage interface 1326 can be configured to provide access to cloud storage sources as if those sources were physically connected to the computer 1302.

The computer 1302 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

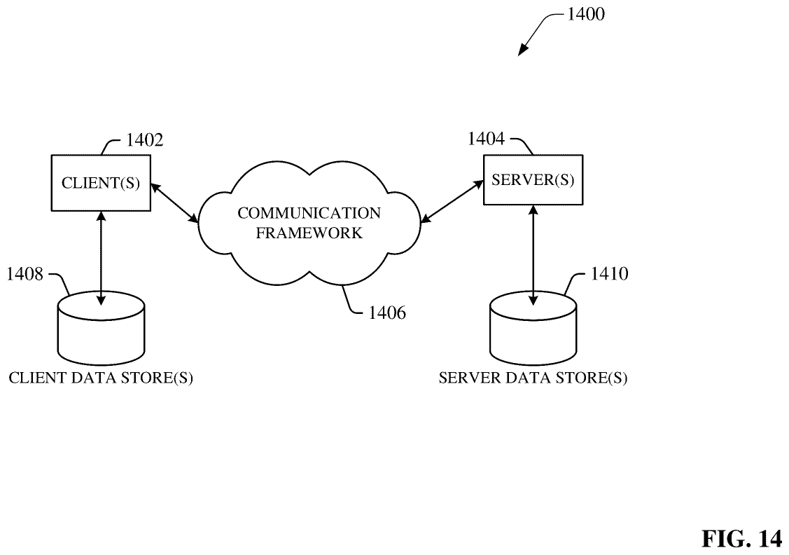

Referring now to FIG. 14, there is illustrated a schematic block diagram of a computing environment 1400 in accordance with this specification. The system 1400 includes one or more client(s) 1402, (e.g., computers, smart phones, tablets, cameras, PDA's). The client(s) 1402 can be hardware and/or software (e.g., threads, processes, computing devices). The client(s) 1402 can house cookie(s) and/or associated contextual information by employing the specification, for example.

The system 1400 also includes one or more server(s) 1404. The server(s) 1404 can also be hardware or hardware in combination with software (e.g., threads, processes, computing devices). The servers 1404 can house threads to perform transformations of media items by employing aspects of this disclosure, for example. One possible communication between a client 1402 and a server 1404 can be in the form of a data packet adapted to be transmitted between two or more computer processes wherein data packets may include coded analyzed headspaces and/or input. The data packet can include a cookie and/or associated contextual information, for example. The system 1400 includes a communication framework 1406 (e.g., a global communication network such as the Internet) that can be employed to facilitate communications between the client(s) 1402 and the server(s) 1404.

Communications can be facilitated via a wired (including optical fiber) and/or wireless technology. The client(s) 1402 are operatively connected to one or more client data store(s) 1408 that can be employed to store information local to the client(s) 1402 (e.g., cookie(s) and/or associated contextual information). Similarly, the server(s) 1404 are operatively connected to one or more server data store(s) 1410 that can be employed to store information local to the servers 1404.

In one exemplary implementation, a client 1402 can transfer an encoded file, (e.g., encoded media item), to server 1404. Server 1404 can store the file, decode the file, or transmit the file to another client 1402. It is noted that a client 1402 can also transfer uncompressed files to a server 1404 and server 1404 can compress the file and/or transform the file in accordance with this disclosure. Likewise, server 1404 can encode information and transmit the information via communication framework 1406 to one or more clients 1402.

The illustrated aspects of the disclosure may also be practiced in distributed computing environments where certain tasks are performed by remote processing devices that are linked through a communications network. In a distributed computing environment, program modules can be located in both local and remote memory storage devices.

The above description includes non-limiting examples of the various embodiments. It is, of course, not possible to describe every conceivable combination of components, modules, or methods for purposes of describing the disclosed subject matter, and one skilled in the art may recognize that further combinations and permutations of the various embodiments are possible. The disclosed subject matter is intended to embrace all such alterations, modifications, and variations that fall within the spirit and scope of the appended claims.

With regard to the various functions performed by the above-described components, modules, devices, circuits, systems, etc., the terms (including a reference to a “means”) used to describe such components or modules are intended to also include, unless otherwise indicated, any structure(s) which performs the specified function of the described component or module (e.g., a functional equivalent), even if not structurally equivalent to the disclosed structure. In addition, while a particular feature of the disclosed subject matter may have been disclosed with respect to only one of several implementations, such feature may be combined with one or more other features of the other implementations as may be desired and advantageous for any given or particular application.

The terms “exemplary” and/or “demonstrative” as used herein are intended to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent structures and techniques known to one skilled in the art. Furthermore, to the extent that the terms “includes,” “has,” “contains,” and other similar words are used in either the detailed description or the claims, such terms are intended to be inclusive—in a manner similar to the term “comprising” as an open transition word-without precluding any additional or other elements.

The term “or” as used herein is intended to mean an inclusive “or” rather than an exclusive “or.” For example, the phrase “A or B” is intended to include instances of A, B, and both A and B. Additionally, the articles “a” and “an” as used in this application and the appended claims should generally be construed to mean “one or more” unless either otherwise specified or clear from the context to be directed to a singular form.

The term “set” as employed herein excludes the empty set, i.e., the set with no elements therein. Thus, a “set” in the subject disclosure includes one or more elements or entities. Likewise, the term “group” as utilized herein refers to a collection of one or more entities.

The description of illustrated embodiments of the subject disclosure as provided herein, including what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as one skilled in the art can recognize. In this regard, while the subject matter has been described herein in connection with various embodiments and corresponding drawings, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

What is claimed is:

1. A system, comprising:
at least one processor; and
at least one memory that stores executable instructions that, when executed by the at least one processor, facilitate performance of operations, comprising:
identifying a file system, wherein the file system comprises a group of files;
based on an attribute applicable to the file system, determining a dataset identifier representative of the file system;
for respective files represented in the group of files, allocating the dataset identifier and allocating respective file identifiers; and
copying the group of files to an object store with respective object names corresponding to the respective files, wherein the copying comprises, for the respective files, assigning the dataset identifier to respective object names and assigning the respective file identifiers to the respective object names.

2. The system of claim 1, wherein the operations further comprise:
in response to a determination that a file of the group of files exceeds a defined object store size threshold, dividing the file into corresponding chunks that do not exceed the defined object store size threshold, wherein the copying of the group of files to the object store comprises copying the corresponding chunks to the object store.

3. The system of claim 1, wherein the copying of the group of files to the object store comprises copying a baseline replication of the file system to the object store.

4. The system of claim 1, wherein the copying of the group of files to the object store comprises copying an incremental replication of the file system to the object store.

5. The system of claim 4, wherein the copying of the incremental replication of the file system to the object store comprises copying a copy-on-write incremental replication of the file system to the object store.

6. The system of claim 5, wherein the group of files comprises a current group of files, and wherein the copying of the copy-on-write incremental replication comprises:
determining changed files in the current group of files relative to a prior version of the group of files in the object store, and determining unchanged files in the current group of files relative to the prior version of the group of files in the object store;
copying the changed files from the file system to a current version of the group of files in the object store, wherein the attribute applicable to the file system corresponds to a respective version of the group of files; and
generating a pointer from the unchanged files from the prior version of the group of files in the object store to the current version of the group of files in the object store.

7. The system of claim 6, wherein the generating the pointer from the unchanged files comprises assigning, for respective unchanged files of the unchanged files, respective pointers in the prior version of the group of files, and wherein the respective pointers point to respective parts of the current version of the group of files.

8. The system of claim 4, wherein the operations further comprise:
in response to a determination that a version of the group of files is to be deleted from the object store, determining a pointer, between the version of the group of files and another version of the group of files in the object store, the other version being other than the version and the other version referencing the version of the group of files to be deleted;
moving a file corresponding to the pointer to the other version of the group of files; and
deleting the version of the group of files from the object store.

9. The system of claim 1, wherein the copying of the group of files to the object store comprises copying the group of files to a corresponding bucket in the object store.

10. The system of claim 1, wherein the object store comprises a cloud-based object store.

11. A non-transitory machine-readable medium, comprising executable instructions that, when executed by at least one processor, facilitate performance of operations, comprising:
determining a file system, wherein the file system comprises data files;
based on an attribute applicable to the file system, determining a globally unique dataset identifier representative of the file system;
for respective data files of the data files, allocating the globally unique dataset identifier and allocating respective globally unique file identifiers; and
copying the data files to an object store with respective object names corresponding to the respective data files of the data files, wherein the copying comprises, for the respective data files of the data files, assigning the globally unique dataset identifier to the respective object names and assigning the respective globally unique file identifiers to the respective object names.

12. The non-transitory machine-readable medium of claim 11, wherein the copying of the files to the object store comprises copying a baseline replication of the file system to the object store.

13. The non-transitory machine-readable medium of claim 11, wherein the copying of the files to the object store comprises copying an incremental replication of the file system to the object store.

14. The non-transitory machine-readable medium of claim 13, wherein the copying of the incremental replication of the file system to the object store comprises copying a copy-on-write incremental replication of the file system to the object store.

15. The non-transitory machine-readable medium of claim 14, wherein the data files comprise current data files, and wherein the copying of the copy-on-write incremental replication comprises:
determining changed files in the current data files relative to a prior version of the data files in the object store and determining unchanged files in the current data files relative to the prior version of the data files in the object store;
copying the changed files from the file system to a current version of the data files in the object store, wherein the attribute comprises a respective version of the data files; and
generating a pointer from the unchanged files from the prior version of the data files in the object store to the current version of the data files in the object store.

16. The non-transitory machine-readable medium of claim 15, wherein the generating the pointer from the unchanged files comprises assigning, for the unchanged files, respective pointers in the prior version of the data files, and wherein the respective pointers point to the current version of the data files.

17. A method, comprising:
identifying, by a device comprising at least one processor, a file system, wherein the file system comprises a group of files;
based on an attribute applicable to the file system, determining, by the device, a dataset identifier representative of the file system;
for each file represented in the group of files, assigning, by the device, the dataset identifier to the file and assigning, by the device, a respective file identifier to the file; and
copying, by the device for each file of the group of files, the file to an object store with a respective object name corresponding to the file, wherein the copying comprises applying the dataset identifier to the respective object name for the file and applying a respective file identifier to the respective object name for the file.

18. The method of claim 17, wherein the copying, for each file, of the file to the object store comprises performing an incremental replication of the file system to the object store.

19. The method of claim 18, further comprising:
in response to a determination that a first version of the group of files is to be deleted from the object store, determining, by the device, a pointer, between the first version of the group of files and a second version of the group of files in the object store, that references the first version of the group of files to be deleted;
moving, by the device, a file of the first version of the group of files corresponding to the pointer to the second version of the group of files; and
deleting, by the device, the first version of the group of files from the object store.

20. The method of claim 18, wherein the copying, for each file, of the file to the object store comprises copying, for each file, the file to a corresponding bucket in the object store.
